(19) United States
(12) Patent Application Publication
(10) Pub. No.: US 2020/0227071 A1
(43) Pub. Date: Jul. 16, 2020

(54) ANALYSING SPEECH SIGNALS

(71) Applicant: Cirrus Logic International Semiconductor Ltd., Edinburgh (GB)

(72) Inventor: John Paul LESSO, Edinburgh (GB)

(73) Assignee: Cirrus Logic International Semiconductor Ltd., Edinburgh (GB)

(21) Appl. No.: 16/829,800

(22) Filed: Mar. 25, 2020

Related U.S. Application Data
(63) Continuation-in-part of application No. 16/156,263, filed on Oct. 10, 2018.
(60) Provisional application No. 62/571,978, filed on Oct. 13, 2017.

(30) Foreign Application Priority Data
Nov. 28, 2017 (GB) 1719731.0

(51) Int. Cl. G10L 25/60; G10L 15/22; G10L 15/02; G10L 25/69; G10L 25/93

(52) U.S. Cl. CPC G10L 25/60; G10L 15/22; G10L 25/93; G10L 25/69; G10L 15/02

(57) ABSTRACT

A method of determining whether a received signal may result from a replay attack comprises receiving an audio signal representing speech, obtaining information about a channel affecting the audio signal, and determining whether the channel has at least one characteristic of a loudspeaker.

### TECHNICAL FIELD

Embodiments described herein relate to methods and devices for analysing speech signals.

### BACKGROUND

Many devices include microphones, which can be used to detect ambient sounds. In many situations, the ambient sounds include the speech of one or more nearby speaker. Audio signals generated by the microphones can be used in many ways. For example, audio signals representing speech can be used as the input to a speech recognition system, allowing a user to control a device or system using spoken commands.

### SUMMARY

According to a first aspect of the invention, there is provided a method of determining whether a received signal may result from a replay attack, the method comprising:
receiving an audio signal representing speech;
obtaining information about a channel affecting said audio signal; and
determining whether the channel has at least one characteristic of a loudspeaker.

The step of obtaining information about the channel affecting said audio signal may comprise: identifying at least one section of the audio signal representing a predetermined word or phrase; extracting first and second components of the section of the audio signal representing first and second acoustic classes of the speech respectively; analysing the first and second components of the audio signal with a model of the first and second acoustic classes of the speech of the predetermined word or phrase; and obtaining information about at the channel affecting said audio signal based on said analysing.

The step of extracting first and second components of the audio signal may comprise: identifying periods when the audio signal contains voiced speech; and identifying remaining periods of speech as containing unvoiced speech.

The step of analysing the first and second components of the audio signal with the models of the first and second acoustic classes of the speech of the enrolled user may comprise: comparing magnitudes of the audio signal at a number of predetermined frequencies with magnitudes in the model of the first and second acoustic classes of the speech.

The model of the first and second acoustic classes of the speech of the predetermined word or phrase may comprise a model of the difference between the first and second acoustic classes of the speech over a range of frequencies, and the step of analysing the first and second components of the audio signal with the model of the first and second acoustic classes of the speech of the predetermined word or phrase may comprise: calculating a difference between the first and second acoustic classes of the speech over a range of frequencies, for said section of the audio signal representing the predetermined word or phrase; and comparing said calculated difference with said model of the difference between the first and second acoustic classes of the speech.

The step of comparing said calculated difference with said model of the difference between the first and second acoustic classes of the speech may comprise: multiplying one of said calculated difference and said model of the difference between the first and second acoustic classes of the speech by a controllable factor, such that the one of said calculated difference and said model of the difference between the first and second acoustic classes of the speech multiplied by said factor becomes equal to the other of said calculated difference and said model of the difference between the first and second acoustic classes of the speech; and taking said controllable factor as representative of the channel.

The step of determining whether the channel has at least one characteristic of a loudspeaker may comprise:
determining whether the channel has a low frequency roll-off.

The step of determining whether the channel has a low frequency roll-off may comprise determining whether the channel decreases at a constant rate for frequencies below a lower cut-off frequency.

The step of determining whether the channel has at least one characteristic of a loudspeaker may comprise:
determining whether the channel has a high frequency roll-off.

The step of determining whether the channel has a high frequency roll-off may comprise determining whether the channel decreases at a constant rate for frequencies above an upper cut-off frequency.

The step of determining whether the channel has at least one characteristic of a loudspeaker may comprise:
determining whether the channel has ripple in a pass-band thereof.

The step of determining whether the channel has ripple in a pass-band thereof may comprise determining whether a degree of ripple over a central part of the pass-band, for example from 100 Hz-10 kHz, exceeds a threshold amount.

According to a further aspect of the invention, there is provided a system for determining whether a received signal may result from a replay attack, the system comprising an input for receiving an audio signal, and being configured for:
receiving an audio signal representing speech;
obtaining information about a channel affecting said audio signal; and
determining whether the channel has at least one characteristic of a loudspeaker.

According to a further aspect of the invention, there is provided a device comprising such a system. The device may comprise a mobile telephone, an audio player, a video player, a mobile computing platform, a games device, a remote controller device, a toy, a machine, or a home automation controller or a domestic appliance.

According to a further aspect of the invention, there is provided a computer program product, comprising a computer-readable tangible medium, and instructions for performing a method according to a previous aspect.

According to a further aspect of the invention, there is provided a non-transitory computer readable storage medium having computer-executable instructions stored thereon that, when executed by processor circuitry, cause the processor circuitry to perform a method according to a previous aspect.

According to a further aspect of the invention, there is provided a method of analysis of an audio signal, the method comprising:
receiving an audio signal representing speech;
extracting first and second components of the audio signal representing first and second acoustic classes of the speech respectively;
calculating a difference between the first and second acoustic classes of the speech over a range of frequencies; and
retrieving a model of a difference between the first and second acoustic classes of the speech of an enrolled user over said range of frequencies;
multiplying one of said calculated difference and said retrieved model by a controllable factor, such that the one of said calculated difference and said retrieved model multiplied by said factor becomes equal to the other of said calculated difference and said retrieved model; and
taking a value of said controllable factor that causes said equality as representative of a channel affecting said audio signal.

### BRIEF DESCRIPTION OF DRAWINGS

For a better understanding of the present invention, and to show how it may be put into effect, reference will now be made to the accompanying drawings, in which:

FIG. 1 illustrates a smartphone.

FIG. 2 is a schematic diagram, illustrating the form of the smartphone.

FIG. 3 is a flow chart illustrating a method of analysing an audio signal;

FIG. 4 is a block diagram illustrating a system for analysing an audio signal;

FIG. 5 illustrates results in the method of FIG. 3;

FIG. 6 is a block diagram illustrating an alternative system for analysing an audio signal;

FIG. 7 is a block diagram illustrating a further alternative system for analysing an audio signal;

FIG. 8 is a block diagram illustrating a further alternative system for analysing an audio signal;

FIG. 9 illustrates a possible relay attack on a voice biometric system;

FIG. 10 illustrates an effect of a replay attack;

FIG. 11 is a flow chart illustrating a method of detecting a replay attack;

FIG. 12 illustrates a method for performing a comparison, in the illustrated systems; and

FIG. 13 is a block diagram illustrating a further alternative system for analysing an audio signal.

### DETAILED DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems. However, for ease of explanation of one embodiment, an illustrative example will be described, in which the implementation occurs in a smartphone.

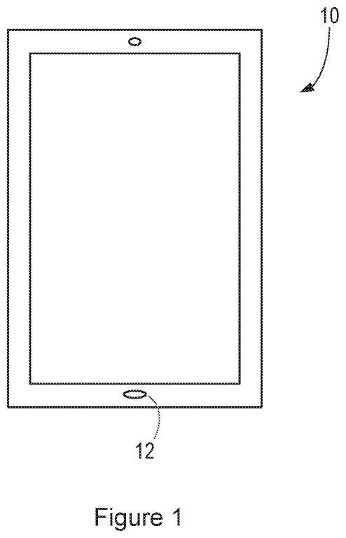

FIG. 1 illustrates a smartphone 10, having a microphone 12 for detecting ambient sounds. In normal use, the microphone is of course used for detecting the speech of a user who is holding the smartphone 10 close to their face.

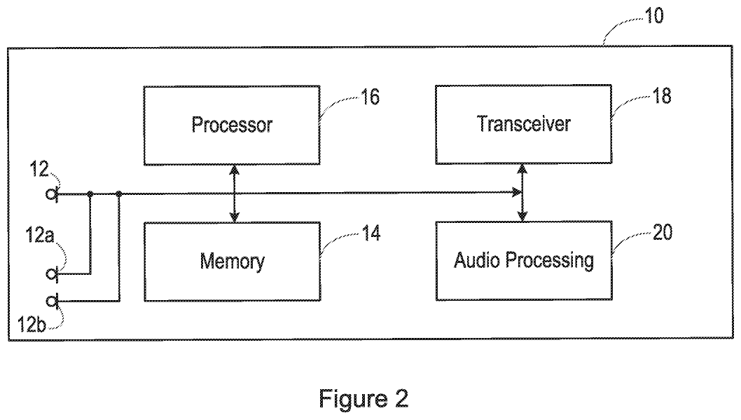

FIG. 2 is a schematic diagram, illustrating the form of the smartphone 10.

Specifically, FIG. 2 shows various interconnected components of the smartphone 10. It will be appreciated that the smartphone 10 will in practice contain many other components, but the following description is sufficient for an understanding of the present invention.

Thus, FIG. 2 shows the microphone 12 mentioned above. In certain embodiments, the smartphone 10 is provided with multiple microphones 12, 12a, 12b, etc.

FIG. 2 also shows a memory 14, which may in practice be provided as a single component or as multiple components. The memory 14 is provided for storing data and program instructions.

FIG. 2 also shows a processor 16, which again may in practice be provided as a single component or as multiple components. For example, one component of the processor 16 may be an applications processor of the smartphone 10.

FIG. 2 also shows a transceiver 18, which is provided for allowing the smartphone 10 to communicate with external networks. For example, the transceiver 18 may include circuitry for establishing an internet connection either over a WiFi local area network or over a cellular network.

FIG. 2 also shows audio processing circuitry 20, for performing operations on the audio signals detected by the microphone 12 as required. For example, the audio processing circuitry 20 may filter the audio signals or perform other signal processing operations.

In this embodiment, the smartphone 10 is provided with voice biometric functionality, and with control functionality. Thus, the smartphone 10 is able to perform various functions in response to spoken commands from an enrolled user. The biometric functionality is able to distinguish between spoken commands from the enrolled user, and the same commands when spoken by a different person. Thus, certain embodiments of the invention relate to operation of a smartphone or another portable electronic device with some sort of voice operability, for example a tablet or laptop computer, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a smartphone or other device, which then transmits the commands to a separate device if the voice biometric functionality is able to confirm that the speaker was the enrolled user.

In some embodiments, while voice biometric functionality is performed on the smartphone 10 or other device that is located close to the user, the spoken commands are transmitted using the transceiver 18 to a remote speech recognition system, which determines the meaning of the spoken commands. For example, the speech recognition system may be located on one or more remote server in a cloud computing environment. Signals based on the meaning of the spoken commands are then returned to the smartphone 10 or other local device.

Methods described herein proceed from the recognition that different parts of a user's speech have different properties.

Specifically, it is known that speech can be divided into voiced sounds and unvoiced or voiceless sounds. A voiced sound is one in which the vocal cords of the speaker vibrate, and a voiceless sound is one in which they do not.

It is now recognised that the voiced and unvoiced sounds have different frequency properties, and that these different frequency properties can be used to obtain useful information about the speech signal.

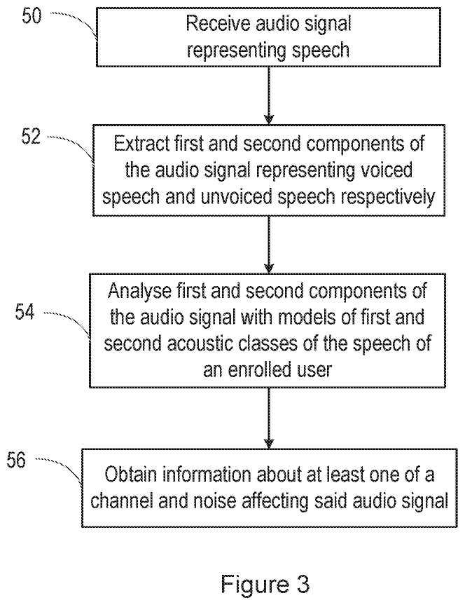

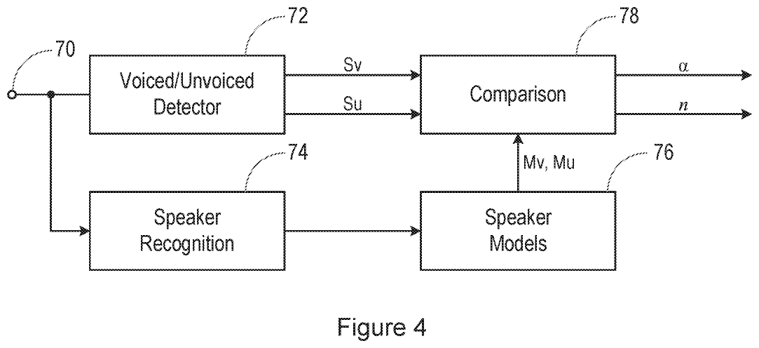

FIG. 3 is a flow chart, illustrating a method of analysing an audio signal, and FIG. 4 is a block diagram illustrating functional blocks in the analysis system.

Specifically, in step 50 in the method of FIG. 3, an audio signal, which is expected to contain speech, is received on an input 70 of the system shown in FIG. 4.

The received signal is divided into frames, which may for example have lengths in the range of 10-100 ms, and then passed to a voiced/unvoiced detection block 72. Thus, in step 52 of the process, first and second components of the audio signal, representing different first and second acoustic classes of the speech, are extracted from the received signal. Extracting the first and second components of the audio signal may comprise identifying periods when the audio signal contains the first acoustic class of speech, and identifying periods when the audio signal contains the second acoustic class of speech. More specifically, extracting the first and second components of the audio signal may comprise identifying frames of the audio signal that contain the first acoustic class of speech, and frames that contain the second acoustic class of speech.

When the first and second acoustic classes of the speech are voiced speech and unvoiced speech, there are several methods that can be used to identify voiced and unvoiced speech, for example: using a deep neural network (DNN), trained against a golden reference, for example using Praat software; performing an autocorrelation with unit delay on the speech signal (because voiced speech has a higher autocorrelation for non-zero lags); performing a linear predictive coding (LPC) analysis (because the initial reflection coefficient is a good indicator of voiced speech); looking at the zero-crossing rate of the speech signal (because unvoiced speech has a higher zero-crossing rate); looking at the short term energy of the signal (which tends to be higher for voiced speech); tracking the first formant frequency F0 (because unvoiced speech does not contain the first format frequency); examining the error in a linear predictive coding (LPC) analysis (because the LPC prediction error is lower for voiced speech); using automatic speech recognition to identify the words being spoken and hence the division of the speech into voiced and unvoiced speech; or fusing any or all of the above.

In the embodiments described further below, the first and second acoustic classes of the speech are voiced speech and unvoiced speech. However, the first and second acoustic classes of the speech may be any phonetically distinguishable acoustic classes. For example, they may be different phoneme classes, for example two different sets of vowels; they may be two different fricatives; or the first class may be fricatives while the second class are sibilants.

The received signal may be supplied to a voice activity detection block, and only supplied to the voiced/unvoiced detection block 72 when it is determined that it does contain speech. In that case, or otherwise when there is reason to believe that the audio signal contains only speech, the step of identifying periods when the audio signal contains unvoiced speech may comprise identifying periods when the audio signal contains voiced speech, and identifying the remaining periods of speech as containing unvoiced speech.

The voiced/unvoiced detection block 72 may for example be based on Praat speech analysis software.

The voiced/unvoiced detection block 72 thus outputs the first component of the audio signal, Sv, representing voiced speech and the second component, Su, representing unvoiced speech.

More specifically, in some embodiments, the first component of the audio signal, Sv, representing voiced speech and the second component, Su, representing unvoiced speech, are averaged spectra of the voiced and unvoiced components of the speech.

By averaged spectra are meant spectra of the speech obtained and averaged over multiple frames.

The spectra can be averaged over enough data to provide reasonable confidence in the information that is obtained about the speech signal. In general terms, this information will become more reliable as more data is used to form the average spectra.

In some cases, spectra averaged over 500 ms of the relevant speech will be enough to provide reliable averaged spectra. The length of time over which the averaged spectra are generated may be adapted based on the articulation rate of the speech, in order to ensure that the speech contains enough phonetic variation to provide a reliable average. The length of time over which the averaged spectra are generated may be adapted based on the content of the speech. If the user is speaking a predetermined known phrase, this may be more discriminative than speaking words of the user's choosing, and so a useful average can be obtained in a shorter period. The process illustrated in FIG. 3 may be performed regularly while the user is speaking, providing regularly updated information at the end of the method as more speech is received. It may then be judged that enough speech has been processed when the results of the method converge to stable values.

The signal received on the input 70 is also passed to a speaker recognition block 74, which performs a voice biometric process to identify the speaker, from amongst a plurality of enrolled speakers. The process of enrolment in a speaker recognition system typically involves the speaker providing a sample of speech, from which specific features are extracted, and the extracted features are used to form a model of the speaker's speech. In use, corresponding features are extracted from a sample of speech, and these are compared with the previously obtained model to obtain a measure of the likelihood that the speaker is the previously enrolled speaker.

In some situations, the speaker recognition system attempts to identify one or more enrolled speaker without any prior expectation as to who the speaker should be. In other situations, there is a prior expectation as to who the speaker should be, for example because there is only one enrolled user of the particular device that is being used, or because the user has already identified themselves in some other way.

In this illustrated example, the speaker recognition block 74 is used to identify the speaker. In other examples, there may be an assumption that the speaker is a particular person, or is selected from a small group of people.

In step 54 of the process shown in FIG. 3, the first and second components of the audio signal are compared with models of the first acoustic class (for example the voiced component) of the speech of an enrolled user and of the second acoustic class (for example the unvoiced component) of the speech of the enrolled user. For example, comparing the first and second components of the audio signal with the models of the voiced and unvoiced speech of the enrolled user may comprise comparing magnitudes of the audio signal at a number of predetermined frequencies with magnitudes in the models.

Thus, in the system shown in FIG. 4, one or more speaker model is stored, for example in a database. Based on the output of the speaker recognition block 74, or based on a prior assumption as to who the speaker is expected to be, one or more speaker model is selected.

In this embodiment, each speaker model contains separate models of the voiced speech and the unvoiced speech of the enrolled user. More specifically, the model of the voiced speech and the model of the unvoiced speech of the enrolled user each comprise amplitude values corresponding to multiple frequencies.

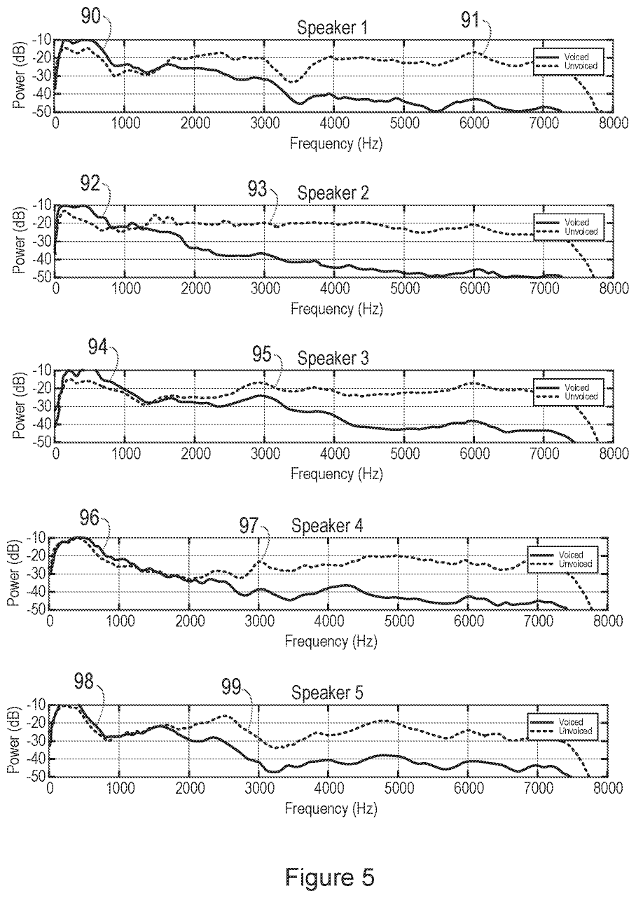

Thus, FIG. 5 shows a multiple speaker models.

Specifically, each speaker model shown in FIG. 5 comprises a long term averaged spectrum of the voiced components of the speech and a long term averaged spectrum of the unvoiced components of the speech. These models are obtained from the respective speakers during previous separate enrolment processes, during which the speakers speak, either uttering predetermined standard test phrases or saying words of their own choosing.

FIG. 5 shows the speaker models for five speakers, labelled Speaker 1-Speaker 5. The model for Speaker 1 comprises the long term averaged spectrum 90 of the voiced components of the speech and the long term averaged spectrum 91 of the unvoiced components of the speech; the model for Speaker 2 comprises the long term averaged spectrum 92 of the voiced components of the speech and the long term averaged spectrum 93 of the unvoiced components of the speech; the model for Speaker 3 comprises the long term averaged spectrum 94 of the voiced components of the speech and the long term averaged spectrum 95 of the unvoiced components of the speech; the model for Speaker 4 comprises the long term averaged spectrum 96 of the voiced components of the speech and the long term averaged spectrum 97 of the unvoiced components of the speech; and the model for Speaker 5 comprises the long term averaged spectrum 98 of the voiced components of the speech and the long term averaged spectrum 99 of the unvoiced components of the speech.

In each case, the model of the speech comprises a vector containing amplitude values at a plurality of frequencies.

The plurality of frequencies may be selected from within a frequency range that contains the most useful information for discriminating between speakers. For example, the range may be from 20 Hz to 8 kHz, or from 20 Hz to 4 kHz.

The frequencies at which the amplitude values are taken may be linearly spaced, with equal frequency spacings between each adjacent pair of frequencies. Alternatively, the frequencies may be non-linearly spaced. For example, the frequencies may be equally spaced on the mel scale.

The number of amplitude values used to form the model of the speech may be chosen depending on the frequency spacings. For example, using linear spacings the model may contain amplitude values for 64 to 512 frequencies. Using mel spacings, it may be possible to use fewer frequencies, for example between 10 and 20 mel-spaced frequencies.

Thus, the model of the voiced speech may be indicated as Mv, where Mv represents a vector comprising one amplitude value at each of the selected frequencies, while the model of the unvoiced speech may be indicated as Mu, where Mu represents a vector comprising one amplitude value at each of the selected frequencies.

As will be appreciated, the received signal, containing the user's speech, will be affected by the properties of the channel, which we take to mean any factor that produces a difference between the user's speech and the speech signal as generated by the microphone alters, and the received signal will also be affected by noise.

Thus, assuming that the channel and the noise are constant over the period during which the received signal is averaged to form the first and second components of the received speech, these first and second components can be expressed as:

Sv=αMv+n, and

Su=αMu+n ,

where
α represents the frequency spectrum of a multiplicative disturbance component, referred to herein as the channel, and
n represents the frequency spectrum of an additive disturbance component, referred to herein as the noise.

Thus, with measurements Sv and Su, and with models Mv and Mu, these two equations can therefore be solved for the two unknowns, α and n.

Thus, for illustrative purposes,

$$α = \frac{( S u - S v )}{( M u - M v )} , and$$

$$n = \frac{( S u M v - S v M u )}{( M u - M v )} .$$

For completeness, it should be noted that, with measurements of the spectrum made at a plurality of frequencies, these two equations are effectively solved at each of the frequencies.

Alternatively, with measurements made at f different frequencies, the equations Sv=α.Mv+n, and Su=α.Mu+n can each be regarded as f different equations to be solved.

In that case, having solved the equations, it may be useful to apply a low-pass filter, or a statistical filter such as a Savitsky-Golay filter, to the results in order to obtain low-pass filtered versions of the channel and noise characteristics.

As an alternative example, a least squares method may be used to obtain solutions to the 2 f different equations.

It will be noted that the calculations set out above rely on determining the difference (Mu−Mv) between the model of the unvoiced speech and the model of the voiced speech. Where these are similar, for example in the range 1.3-1.6 kHz in the case of Speaker 1 in FIG. 5, then any small uncertainties in either of the models will potentially be magnified into large errors in the calculated values for the channel and/or the noise. Thus, the calculated values in any such frequency ranges may be given lower significance in any subsequent processing steps that use the calculated values, for example a reduced can weight applied to the values used in later processing steps. Alternatively, when it is known in advance that the model of the unvoiced speech and the model of the voiced speech are similar in a particular frequency range, the equations given above need not be solved for frequencies in this range.

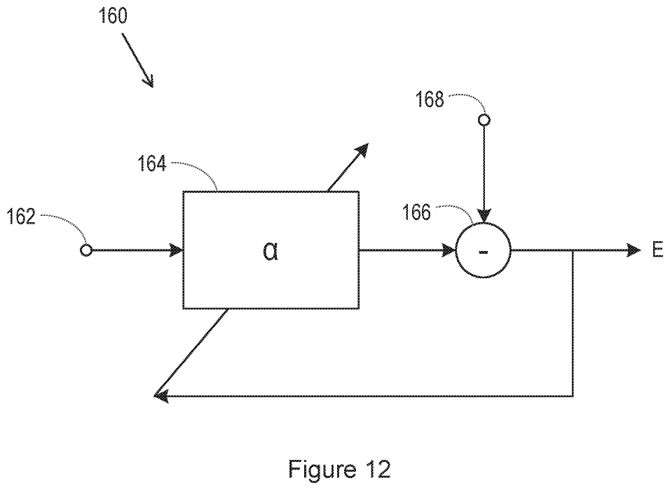

FIG. 12 illustrates an alternative mechanism for obtaining information about the channel.

As noted above, there is a relationship between the frequency spectra of voiced speech and unvoiced speech. The multiplicative disturbance component, that is referred to herein as the channel, is the ratio of the differences between the voiced and unvoiced components of speech, as generated by the relevant source, and as detected.

Thus, as described above, and assuming that the models of the speaker's voiced and unvoiced components of speech are accurate models of the speech that is generated by the source:

α=^{(Su-Sv)}/_{(Mu-Mv)}.

FIG. 12 shows a system 160 in which separate models of the voiced and unvoiced components of the speech of one or more speaker are derived and stored.

However, if it is only the channel (that is, the multiplicative disturbance component), that is of interest, and not the noise (that is, the additive disturbance component), it is only necessary to derive and store a model of the difference between the long term frequency spectra of the voiced and unvoiced components of the speech, i.e. (Mv−Mu), for the one or more speaker of interest.

Thus, in a system based on the system shown in FIG. 4, the or each speaker model comprises a frequency-dependent characteristic of the difference between the long term frequency spectra of the voiced and unvoiced components of the speech.

Similarly, the output of the voiced/unvoiced detection block 72 can be used to generate a frequency-dependent characteristic of the difference (Sv−Su) between the frequency spectra of the voiced and unvoiced components of the speech being detected over any convenient time period.

These differences can then be used in a system identification process, for example using a least-squares-type method, in order to obtain a frequency-dependent characteristic of the channel.

Thus, FIG. 12 (illustrating a least mean squares (LMS) method) shows the model of (Mv−Mu) being retrieved and applied to a first input 162 of the system 160. The model of (Mv−Mu) is then applied to an input of a controllable multiplier 164, which multiplies the input signal by a frequency-dependent factor α.

The output of the multiplier 164 is applied to a subtractor 166.

The difference (Sv−Su) between the frequency spectra of the voiced and unvoiced components of the speech that is detected over any convenient time period is calculated and applied to a second input 168 of the system 160, and then applied to a second input of the subtractor 166.

The output E of the subtractor 166 is therefore the difference between the two inputs, as a function of frequency, i.e.:

E=α(Mv−Mu)−(Sv−Su)
E can then be taken as an error signal, and used to control the frequency-dependent multiplication factor α that is applied by the controllable multiplier 164, in order to achieve a situation where E=0.

When E=0:

α(Mv−Mu)−(Sv−Su)=0

That is:

$$α = \frac{( S ν - S u )}{( M ν - M u )}$$

Thus, the value of α, as a function of frequency, that leads to E=0, represents the frequency-dependent channel that is influencing the detected sounds.

It will be noted that, while FIG. 12 shows the features of the unvoiced speech being subtracted from the features of the voiced speech, this could be reversed without affecting the analysis.

That is, it would be equally possible to derive and store a model of the difference between the long term frequency spectra of the unvoiced and voiced components of the speech, i.e. (Mu−Mv), for the one or more speaker of interest, and similarly the output of the voiced/unvoiced detection block 72 can be used to generate a frequency-dependent characteristic of the difference (Su−Sv) between the frequency spectra of the unvoiced and voiced components of the speech being detected over any convenient time period.

Similarly, while FIG. 12 shows the model (Mv−Mu) being retrieved and applied to the first input 162 of the system 160, and the difference (Sv−Su) between the frequency spectra of the voiced and unvoiced components of the actual speech being applied to the second input 168, these inputs can also be reversed.

In that case, the value of a, as a function of frequency, that leads to E=0, represents the inverse of the frequency-dependent channel that is influencing the detected sounds.

If it is desired to remove the effect of the channel by applying the received signals to an appropriate filter, then the value of a that represents the inverse of the frequency-dependent channel is the representation of the filter that is required to remove the effect of the channel.

Thus, as shown at step 56 of the process shown in FIG. 3, information is obtained about the channel and/or the noise affecting the audio signal.

This information can be used in many different ways.

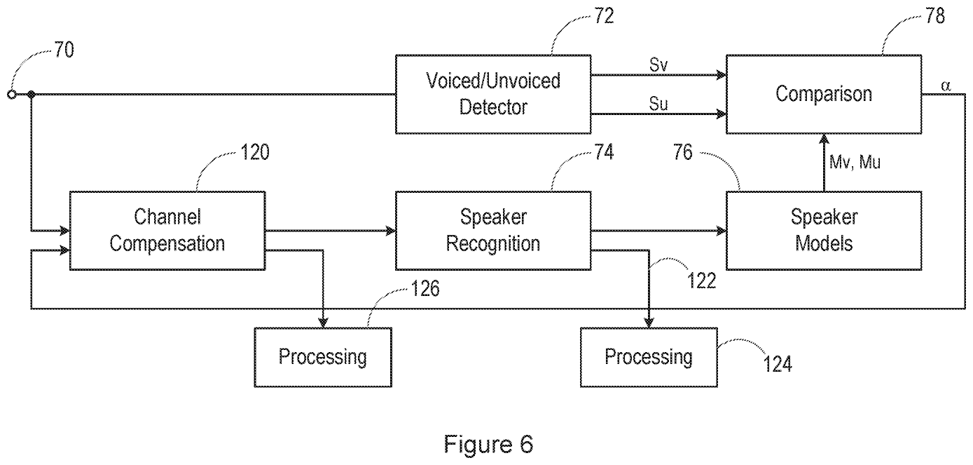

FIG. 6 illustrates one such use. The system shown in FIG. 6 is similar to the system of FIG. 4, and the same reference numerals are used to refer to the same components of the system.

In the system of FIG. 6, the comparison block 78 is used to obtain information about the channel a that is affecting the received audio signal. Specifically, the comparison block 78 may be used to obtain the frequency spectrum of the channel. This can be used to compensate the received audio signal to take account of the channel.

For one example, FIG. 6 shows a channel compensation block 120, to which the audio signal received on the input 70 is supplied. The channel compensation block 120 also receives the frequency spectrum of the channel α. The channel compensation block 120 acts to remove the effects of the channel from the received signal, by dividing the received signal by the calculated channel α, before the received signal is passed to the speaker recognition block 74.

Thus, the output of the speaker recognition block 74, on the output 122, can be improved. That is, it can provide more reliable information about the identity of the speaker. This can then be supplied to a processing block 124 and used for any required purposes.

The output of the channel compensation block 120, containing the received signal after the effects of the channel have been removed, can be supplied to any suitable processing block 126, such as a speech recognition system, or the like.

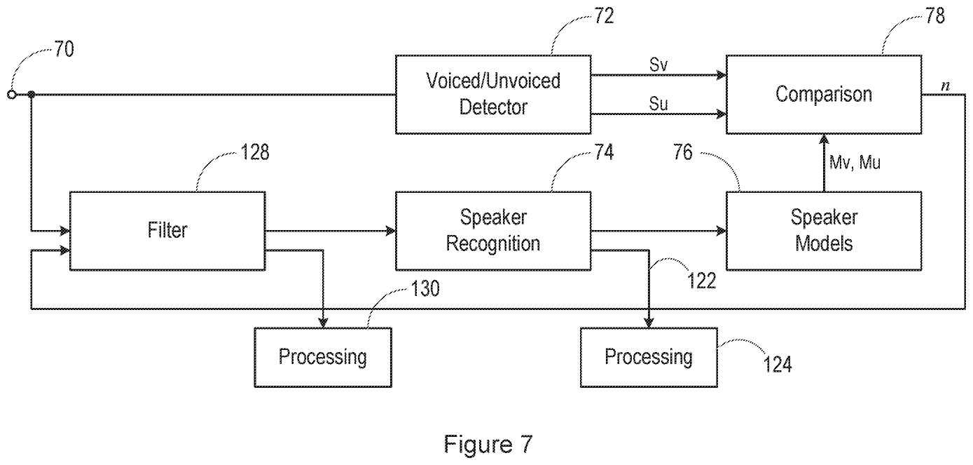

FIG. 7 illustrates another such use. The system shown in FIG. 7 is similar to the system of FIG. 4, and the same reference numerals are used to refer to the same components of the system.

In the system of FIG. 7, the comparison block 78 is used to obtain information about the noise n that is affecting the received audio signal. Specifically, the comparison block 78 may be used to obtain the frequency spectrum of the noise. This can be used to take account of the noise when processing the received audio signal.

For one example, FIG. 7 shows a filter block 128, to which the audio signal received on the input 70 is supplied. The filter block 128 also receives the frequency spectrum of the noise n. The filter block 128 acts so as to ensure that noise does not adversely affect the operation of the speaker recognition block 74.

For example, the calculated noise characteristic, n, can be subtracted from the received signal before any further processing takes place.

In another example, where the level of noise exceeds a predetermined threshold level at one or more frequencies, such that the operation of the speaker recognition block 74 could be compromised, the filter block 128 can remove the corrupted components of the received audio signal at those frequencies, before passing the signal to the speaker recognition block 74. Alternatively, these components could instead be flagged as being potentially corrupted, before being passed to the speaker recognition block 74 or any further signal processing block.

Thus, the output of the speaker recognition block 74, on the output 122, can be improved. That is, it can provide more reliable information about the identity of the speaker. This can then be supplied to any suitable processing block 124, and used for any required purposes.

The output of the filter block 128, containing the received signal after the frequency components that are excessively corrupted by noise have been removed, can be supplied to any suitable processing block 130, such as a speech recognition system, or the like.

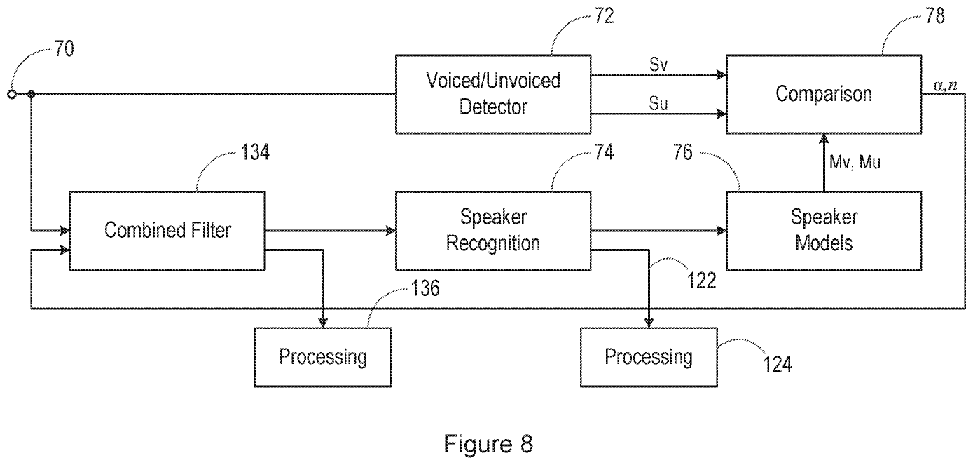

FIG. 8 illustrates another such use. The system shown in FIG. 8 is similar to the system of FIG. 4, and the same reference numerals are used to refer to the same components of the system.

In the system of FIG. 8, the comparison block 78 is used to obtain information about the channel a and the noise n that are affecting the received audio signal. Specifically, the comparison block 78 may be used to obtain the frequency spectrum of the channel and of the noise. This can be used to take account of the channel and the noise when processing the received audio signal.

For one example, FIG. 8 shows a combined filter block 134, to which the audio signal received on the input 70 is supplied. The combined filter block 134 also receives the frequency spectrum of the channel a and the noise n. The combined filter block 134 acts so as to ensure that channel effects and noise do not adversely affect the operation of the speaker recognition block 74.

For example, the calculated noise characteristic, n, can be subtracted from the received signal, and the remaining signal can be divided by the calculated channel a, before any further processing takes place.

Thus, the output of the speaker recognition block 74, on the output 122, can be improved. That is, it can provide more reliable information about the identity of the speaker. This can then be supplied to any suitable processing block 124, and used for any required purposes.

The output of the combined filter block 134, containing the received signal after the effects of the channel and the noise have been removed, can be supplied to any suitable processing block 136, such as a speech recognition system, or the like.

A further use of the information obtained about the channel and/or the noise affecting the audio signal is to overcome an attempt to deceive a voice biometric system by playing a recording of an enrolled user's voice in a so-called replay or spoof attack.

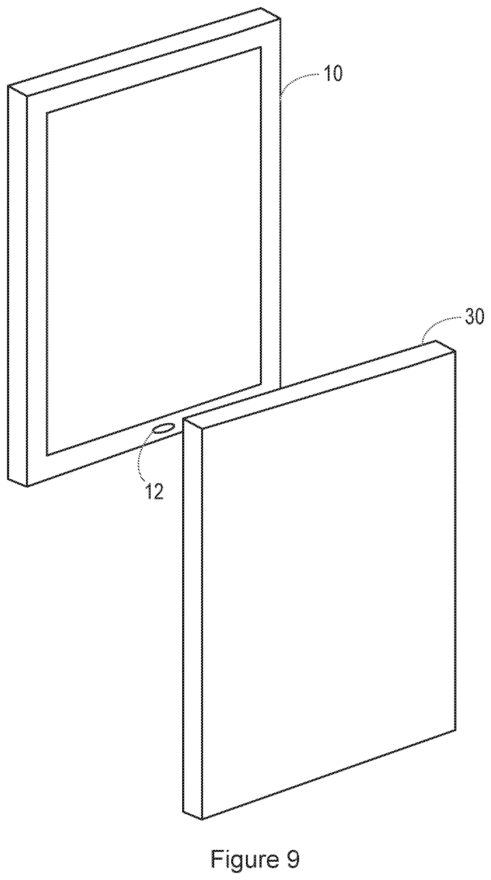

FIG. 9 shows an example of a situation in which a replay attack is being performed. Thus, in FIG. 9, the smartphone 10 is provided with voice biometric functionality. In this example, the smartphone 10 is in the possession, at least temporarily, of an attacker, who has another smartphone 30. The smartphone 30 has been used to record the voice of the enrolled user of the smartphone 10. The smartphone 30 is brought close to the microphone inlet 12 of the smartphone 10, and the recording of the enrolled user's voice is played back. If the voice biometric system is unable to determine that the enrolled user's voice that it recognises is a recording, the attacker will gain access to one or more services that are intended to be accessible only by the enrolled user.

It is known that smartphones, such as the smartphone 30, are typically provided with loudspeakers that are of relatively low quality. Thus, the recording of an enrolled user's voice played back through such a loudspeaker will not be a perfect match with the user's voice, and this fact can be used to identify replay attacks.

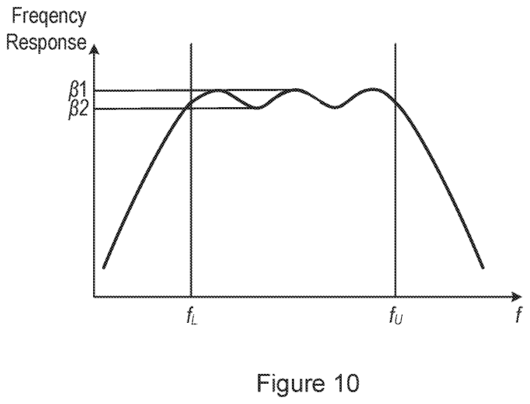

FIG. 10 illustrates the frequency response of a typical loudspeaker. Thus, at frequencies below a lower threshold frequency f_{L}, the loudspeaker suffers from low-frequency roll-off, as the bass response is limited by the size of the loudspeaker diaphragm. At frequencies above an upper threshold frequency fᵤ, the loudspeaker suffers from high-frequency roll-off. At frequencies between the lower threshold frequency f_{L} and the upper threshold frequency fᵤ, there is a degree of pass-band ripple, as the magnitude of the response varies periodically between β₁ and β₂.

The size of these effects will be determined by the quality of the loudspeaker. For example, in a high quality loudspeaker, the lower threshold frequency f_{L} and the upper threshold frequency f_{U} should be such that there is minimal low-frequency roll-off or high-frequency roll-off within the frequency range that is typically audible to humans. However, size and cost constraints mean that many commercially available loudspeakers, such as those provided in smartphones such as the smartphone 30, do suffer from these effects to some extent.

Similarly, the magnitude of the pass-band ripple, that is the difference between β₁ and β₂, will also depend on the quality of the loudspeaker.

If the voice of a speaker is played back through a loudspeaker whose frequency response has the general form shown in FIG. 10, then this may be detectable in the received audio signal containing the speech of that speaker. It has previously been recognised that, if a received audio signal has particular frequency characteristics, that may be a sign that the received audio signal is the result of a replay attack. However, the frequency characteristics of the received signal depend on other factors, such as the frequency characteristics of the speech itself, and the properties of any ambient noise, and so it is difficult to make a precise determination that a signal comes from a replay attack based only on the frequency characteristics of the received signal.

However, the method shown in FIG. 3, and described with reference thereto, can be used to make a more reliable determination as to whether a signal comes from a replay attack.

In one possibility, as shown in FIG. 7, the frequency characteristic of the ambient noise is determined, and this is subtracted from the received audio signal by means of the filter 128. The received signal, with noise removed, is supplied to a processing block 130, which in this case may be a replay attack detection block.

For example, the replay attack detection block may perform any of the methods disclosed in EP-2860706A, such as testing whether a particular spectral ratio (for example a ratio of the signal energy from 0-2 kHz to the signal energy from 2-4 kHz) has a value that may be indicative of replay through a loudspeaker, or whether the ratio of the energy within a certain frequency band to the energy of the complete frequency spectrum has a value that may be indicative of replay through a loudspeaker.

In another possibility, the method shown in FIG. 3 is used to determine the frequency characteristic of the channel that affects the received speech. If the speech has been played back through a loudspeaker, the frequency response of the loudspeaker should be visible in the frequency characteristic of the channel.

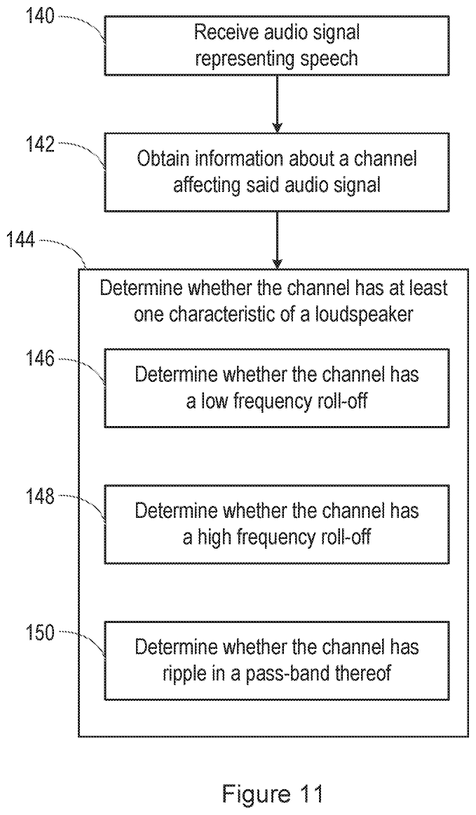

FIG. 11 is a flow chart, illustrating a method of determining whether the received signal may result from a replay attack.

In the method of FIG. 11, in step 140, an audio signal is received, representing speech.

In step 142, information is obtained about a channel affecting said audio signal. For example, the information about the channel may be obtained by the method shown in FIG. 3.

As described above, the method shown in FIG. 3 can be used to obtain information about the channel and/or noise that are influencing the sounds that are detected, using prior information about the characteristics of a previously identified speaker.

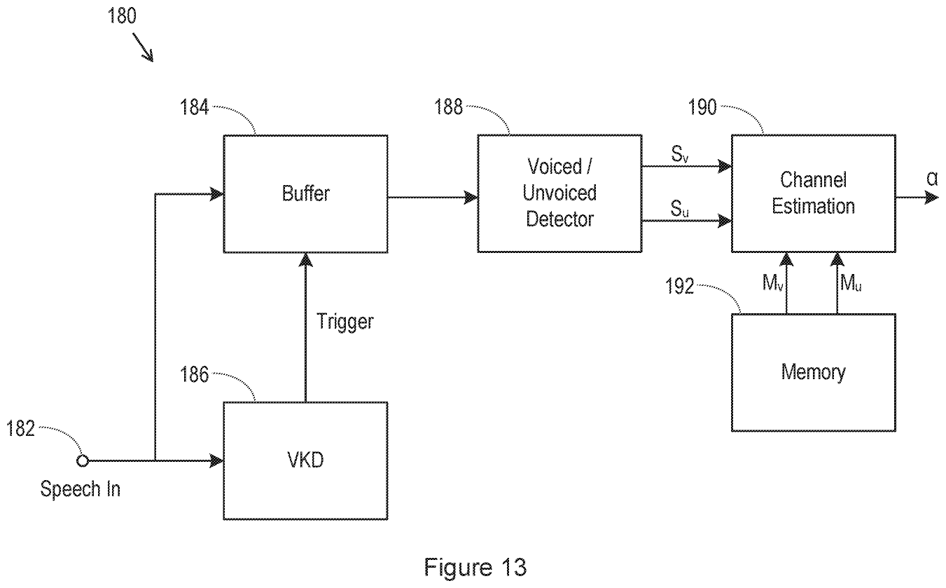

FIG. 13 is a block diagram illustrating a further alternative system for analysing an audio signal, and in particular for obtaining information about the channel.

The system shown in FIG. 13 is of particular use in situations where there is no available prior information about the characteristics of the speaker, but there is information about the characteristics of the words that are being spoken.

FIG. 13 shows a system 180 in which a signal that contains speech is applied to an input 182. For example, the input signal may be generated by applying a microphone signal to a voice activity detection block so that it consists mainly of speech. Alternatively, the input signal may be the microphone signal itself.

The received signal is passed to a buffer 184, where it is stored.

The received signal is also passed to a voice keyword detection (VKD) block 186, which attempts to identify one or more predefined word or phrase in the speech that is represented by the received signal.

For example, where the system is implemented in a wider speech recognition system that uses a wake phrase, such as “Hello phone”, to activate the speech recognition from a sleep mode, the wake phrase may be a suitable predefined word or phrase.

In other implementations, there may be more than one predefined word or phrase. For example, where the context means that the speech can be expected to contain specific words or phrases, those words or phrases may be suitable predefined words or phrases for use in the system of FIG. 13.

When the VKD block 186 detects the predefined word or phrase, it sends a suitable trigger signal to the buffer 184, which causes the buffer 184 to output the relevant part of the received signal, containing that predefined word or phrase. For example, the VKD block 186 might generate suitable flags to indicate the beginning and end of the predefined word or phrase in the received signal.

That part of the signal is then divided into frames, which may for example have lengths in the range of 10-100 ms, and is then passed to a voiced/unvoiced detection block 188. Thus, first and second components of the audio signal, representing different first and second acoustic classes of the speech, are extracted from the received signal. More specifically, frames of the audio signal that contain the first acoustic class of speech, and frames that contain the second acoustic class of speech, are identified.

In this example, where the first and second acoustic classes of the speech are voiced speech and unvoiced speech, there are several methods that can be used to identify voiced and unvoiced speech, for example: using a deep neural network (DNN), trained against a golden reference, for example using Praat software; performing an autocorrelation with unit delay on the speech signal (because voiced speech has a higher autocorrelation for non-zero lags); performing a linear predictive coding (LPC) analysis (because the initial reflection coefficient is a good indicator of voiced speech); looking at the zero-crossing rate of the speech signal (because unvoiced speech has a higher zero-crossing rate); looking at the short term energy of the signal (which tends to be higher for voiced speech); tracking the first formant frequency F0 (because unvoiced speech does not contain the first format frequency); examining the error in a linear predictive coding (LPC) analysis (because the LPC prediction error is lower for voiced speech); using automatic speech recognition to identify the words being spoken and hence the division of the speech into voiced and unvoiced speech; or fusing any or all of the above.

In the illustrated embodiments, the first and second acoustic classes of the speech are voiced speech and unvoiced speech. However, the first and second acoustic classes of the speech may be any phonetically distinguishable acoustic classes. For example, they may be different phoneme classes, for example two different sets of vowels; they may be two different fricatives; or the first class may be fricatives while the second class are sibilants.

The voiced/unvoiced detection block 188 thus outputs the first component of the audio signal, Sv, representing voiced speech and the second component, Su, representing unvoiced speech.

More specifically, in some embodiments, the first component of the audio signal, Sv, representing voiced speech and the second component, Su, representing unvoiced speech, are averaged spectra of the voiced and unvoiced components of the speech. By averaged spectra are meant spectra of the speech obtained and averaged over multiple frames.

The spectra can be averaged over enough data to provide reasonable confidence in the information that is obtained about the speech signal. In general terms, this information will become more reliable as more data is used to form the average spectra.

The first and second components of the received signal, that is, the parts of the received signal representing voiced speech and unvoiced speech in this example, are passed to a channel estimation block 190.

The channel estimation block 190 also receives models of the first acoustic class (for example the voiced component) and of the second acoustic class (for example the unvoiced component) of the speech, for that predefined word or phrase detected by the VKD block 186.

That is, in this example, the memory 192 contains models, Mv and Mu respectively, of the voiced and unvoiced components of the predefined word or phrase, averaged over a variety of different speakers. Thus, the models capture the expected content of the speech for a range of speakers, and so they form a suitable basis for the comparison performed by the channel estimation block 190, even though the identity of the person speaking is not known.

In one embodiment, there are separate models for male and female speakers. That is there are models, Mvf and Muf respectively, of the voiced and unvoiced components of the predefined word or phrase, averaged over a variety of different female speakers, and there are models, Mvm and Mum respectively, of the voiced and unvoiced components of the predefined word or phrase, averaged over a variety of different male speakers. The fundamental frequency, f0, of the received speech signal is then used to determine whether the speaker is more likely to be male or female. Received signals with a fundamental frequency above a threshold are compared with the models Mvf and Muf, while received signals with a fundamental frequency below the threshold are compared with the models Mvm and Mum.

In the case where the VKD block 186 is configured to detect more than one predefined word or phrase, then the memory 192 contains respective models of the voiced and unvoiced components of each of those predefined words or phrases, each averaged over a variety of different speakers. In addition, when the VKD block 186 detects one of those predefined words or phrases, it sends a signal to the memory 192 to indicate which of them has been detected, so that the relevant models are supplied to the channel estimation block 190, for comparison with the received speech.

The comparison performed by the channel estimation block 190 is as described previously with reference to FIG. 4.

For example, information about the channel may be obtained by means of a mechanism as illustrated in FIG. 12, and as described above.

In this case, a model of the difference between the long term frequency spectra of the voiced and unvoiced components of the speech, i.e. (Mv−Mu), is stored for the at least one predefined word or phrase of interest.

Similarly, the output of the voiced/unvoiced detection block 188 can be used to generate a frequency-dependent characteristic of the difference (Sv−Su) between the frequency spectra of the voiced and unvoiced components of the speech.

These differences can then be used in a system identification process, in order to obtain a frequency-dependent characteristic of the channel.

Thus, FIG. 12 shows the model of (Mv−Mu) being retrieved and applied to a first input 162 of the system 160. The model of (Mv−Mu) is then applied to an input of a controllable multiplier 164, which multiplies the input signal by α.

The output of the multiplier 164 is applied to a subtractor 166.

The difference (Sv−Su) between the frequency spectra of the voiced and unvoiced components of the speech that is detected over any convenient time period is calculated and applied to a second input 168 of the system 160, and then applied to a second input of the subtractor 166.

The frequency-dependent output E of the subtractor 166 is therefore the difference between the two inputs, i.e.:

E=α(Mv−Mu)−(Sv−Su)

E can then be taken as an error signal, and used to control the frequency-dependent multiplication factor a that is applied by the controllable multiplier 164, in order to achieve a situation where E=0.

When E=0:

α(Mv−Mu)−(Sv−Su)=0

That is:

$$α = \frac{( S ν - S u )}{( M ν - M u )}$$

Thus, the value of α, as a function of frequency, that leads to E=0, represents the frequency-dependent channel that is influencing the detected sounds.

It will be noted that, while FIG. 12 shows the features of the unvoiced speech being subtracted from the features of the voiced speech, this could be reversed without affecting the analysis.

That is, it would be equally possible to derive and store a model of the difference between the long term frequency spectra of the unvoiced and voiced components of the speech, i.e. (Mu−Mv), for the one or more predefined word or phrase, and similarly the output of the voiced/unvoiced detection block 72 can be used to generate a frequency-dependent characteristic of the difference (Su−Sv) between the frequency spectra of the unvoiced and voiced components of the speech being detected over any convenient time period.

Similarly, while FIG. 12 shows the model (Mv−Mu) being retrieved and applied to the first input 162 of the system 160, and the difference (Sv−Su) between the frequency spectra of the voiced and unvoiced components of the actual speech being applied to the second input 168, these inputs can also be reversed.

In that case, the value of α, as a function of frequency, that leads to E=0, represents the inverse of the frequency-dependent channel that is influencing the detected sounds.

The information about the channel can then be used jn a determination as to whether the received signal comes from a live speaker, or from a recording.

Returning to the method shown in FIG. 11, in step 144, it is determined whether the channel has at least one characteristic of a loudspeaker.

As shown at step 146, determining whether the channel has at least one characteristic of a loudspeaker may comprise determining whether the channel has a low frequency roll-off. For example, the low-frequency roll-off may involve the measured channel decreasing at a relatively constant rate, such as 6 dB per octave, for frequencies below a lower cut-off frequency fL, which may for example be in the range 50 Hz-700 Hz.

As shown at step 148, determining whether the channel has at least one characteristic of a loudspeaker may comprise determining whether the channel has a high frequency roll-off. For example, the high-frequency roll-off may involve the measured channel decreasing at a relatively constant rate, such as 6 dB per octave, for frequencies above an upper cut-off frequency fu, which may for example be in the range 18 kHz-24 kHz.

As shown at step 150, determining whether the channel has at least one characteristic of a loudspeaker may comprise determining whether the channel has ripple in a pass-band thereof. For example, this may comprise applying a Welch periodogram to the channel, and determining whether there is a predetermined amount of ripple in the characteristic. A degree of ripple (that is, a difference between β₁ and β₂ in the frequency response shown in FIG. 10) exceeding a threshold value, such as 1 dB, and with a peak-to-trough frequency of about 100 Hz, over the central part of the pass-band, for example from 100 Hz-10 kHz, can be regarded as characteristic of a loudspeaker.

For example, two or three of the steps 146, 148 and 150 may be performed, with the results being applied to a classifier, to determine whether the results of those steps are indeed characteristic of a loudspeaker frequency response.

As a further example, the channel frequency response can be applied as an input to a neural network, which has been trained to distinguish channels that are characteristic of loudspeakers from other channels.

If it is determined that the channel has a characteristic of a loudspeaker, then it may be determined, perhaps on the basis of other indicators too, that the received audio signal is the result of a replay attack. In that case, the speech in the received audio signal may be disregarded when attempting to verify that the speaker is the expected enrolled speaker.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A method of determining whether a received signal may result from a replay attack, the method comprising:
receiving an audio signal representing speech;
obtaining information about a channel affecting said audio signal; and
determining whether the channel has at least one characteristic of a loudspeaker.

2. A method according to claim 1, wherein obtaining information about the channel affecting said audio signal comprises:
identifying at least one section of the audio signal representing a predetermined word or phrase;
extracting first and second components of the section of the audio signal representing first and second acoustic classes of the speech respectively;
analysing the first and second components of the audio signal with a model of the first and second acoustic classes of the speech of the predetermined word or phrase; and
obtaining information about at the channel affecting said audio signal based on said analysing.

3. A method according to claim 2, wherein extracting first and second components of the audio signal comprises:
identifying periods when the audio signal contains voiced speech; and
identifying remaining periods of speech as containing unvoiced speech.

4. A method according to claim 2, wherein analysing the first and second components of the audio signal with the models of the first and second acoustic classes of the speech of the enrolled user comprises:
comparing magnitudes of the audio signal at a number of predetermined frequencies with magnitudes in the model of the first and second acoustic classes of the speech.

5. A method according to claim 2,
wherein the model of the first and second acoustic classes of the speech of the predetermined word or phrase comprises a model of the difference between the first and second acoustic classes of the speech over a range of frequencies, and
wherein analysing the first and second components of the audio signal with the model of the first and second acoustic classes of the speech of the predetermined word or phrase comprises:
calculating a difference between the first and second acoustic classes of the speech over a range of frequencies, for said section of the audio signal representing the predetermined word or phrase; and
comparing said calculated difference with said model of the difference between the first and second acoustic classes of the speech.

6. A method according to claim 5, comprising comparing said calculated difference with said model of the difference between the first and second acoustic classes of the speech by:
multiplying one of said calculated difference and said model of the difference between the first and second acoustic classes of the speech by a controllable factor, such that the one of said calculated difference and said model of the difference between the first and second acoustic classes of the speech multiplied by said factor becomes equal to the other of said calculated difference and said model of the difference between the first and second acoustic classes of the speech; and
taking said controllable factor as representative of the channel.

7. A method according to claim 2, wherein the first and second acoustic classes of the speech comprise voiced speech and unvoiced speech.

8. A method according to claim 2, wherein the first and second acoustic classes of the speech comprise first and second phoneme classes. 30

9. A method according to claim 2, wherein the first and second acoustic classes of the speech comprise first and second fricatives.

10. A method according to claim 2, wherein the first and second acoustic classes of the speech comprise fricatives and sibilants.

11. A method according to claim 1, wherein determining whether the channel has at least one characteristic of a loudspeaker comprises:
determining whether the channel has a low frequency roll-off.

12. A method according to claim 11, wherein determining whether the channel has a low frequency roll-off comprises determining whether the channel decreases at a constant rate for frequencies below a lower cut-off frequency.

13. A method according to claim 1, wherein determining whether the channel has at least one characteristic of a loudspeaker comprises:
determining whether the channel has a high frequency roll-off.

14. A method according to claim 13, wherein determining whether the channel has a high frequency roll-off comprises determining whether the channel decreases at a constant rate for frequencies above an upper cut-off frequency.

15. A method according to claim 1, wherein determining whether the channel has at least one characteristic of a loudspeaker comprises:
determining whether the channel has ripple in a pass-band thereof.

16. A method according to claim 15, wherein determining whether the channel has ripple in a pass-band thereof comprises determining whether a degree of ripple over a central part of the pass-band, for example from 100 Hz-10 kHz, exceeds a threshold amount.

17. A system for determining whether a received signal may result from a replay attack, the system comprising an input for receiving an audio signal, and being configured for:
receiving an audio signal representing speech;
obtaining information about a channel affecting said audio signal; and
determining whether the channel has at least one characteristic of a loudspeaker.

18. A device comprising a system as claimed in claim 17.

19. A device as claimed in claim 18, wherein the device comprises a mobile telephone, an audio player, a video player, a mobile computing platform, a games device, a remote controller device, a toy, a machine, or a home automation controller or a domestic appliance.

20. A computer program product, comprising a non-transitory computer-readable tangible medium, and instructions for performing a method according to claim 1.

21. A method of analysis of an audio signal, the method comprising:
receiving an audio signal representing speech;
extracting first and second components of the audio signal representing first and second acoustic classes of the speech respectively;
calculating a difference between the first and second acoustic classes of the speech over a range of frequencies; and
retrieving a model of a difference between the first and second acoustic classes of the speech of an enrolled user over said range of frequencies;
multiplying one of said calculated difference and said retrieved model by a controllable factor, such that the one of said calculated difference and said retrieved model multiplied by said factor becomes equal to the other of said calculated difference and said retrieved model; and
taking a value of said controllable factor that causes said equality as representative of a channel affecting said audio signal.
